(19) United States
(12) Patent Application Publication
(10) Pub. No.: US 2023/0150725 A1
(43) Pub. Date: May 18, 2023

(54) CONTAINER SYSTEM AND COUPLING MECHANISM THEREFORE

(71) Applicant: KETER HOME AND GARDEN PRODUCTS LTD, Herzliya (IL)

(72) Inventors: Yaron BARON, Kibbutz Gvat (IL); Ayala VARDI-BOUGAY, Kefar Veradim (IL); Omer MENASHRI, Kibbutz Afikim (IL)

(21) Appl. No.: 17/917,680

(22) PCT Filed: May 18, 2021
(86) PCT No.: PCT/IL2021/050565

§ 371 Date: Oct. 7, 2022

(30) Foreign Application Priority Data
May 26, 2020 (IL) 274945

(51) Int. Cl. B65D 21/02

(52) U.S. Cl. CPC B65D 21/023; B25H 3/02

(57) ABSTRACT

The present disclosure is directed to a container system and more specifically the disclosure is directed to a coupling mechanism for a container system.

### TECHNOLOGICAL FIELD

The present disclosure is directed to a container system and more specifically the disclosure is directed to a coupling mechanism for a container system.

### BACKGROUND ART

References considered to be relevant as background to the presently disclosed subject matter are listed below:
WO2016142935
WO2019239404

Acknowledgement of the above references herein is not to be inferred as meaning that these are in any way relevant to the patentability of the presently disclosed subject matter.

### BACKGROUND

WO2016142935 is directed to a container assembly comprising a container for storage and transport of goods comprising at least one side wall and a bottom wall defining together an interior space and a cover for closing the opening, having a top surface, wherein the cover comprises at least one latch member movable between at least a first position and a second position and wherein the container comprises a retaining member on the at least one side wall and positioned parallel to the latch member such that the latch member is configured for engaging with a retaining member of another container to connect the container to the at least one other container.

WO2019239404 discloses a coupling mechanism for detachably attaching two or more utility modules to one another, utility assembles, mobile carriers and other attachable modules and articles.

### GENERAL DESCRIPTION

The present disclosure provides a container assembly and a coupling mechanism for detachably articulating a first container over a second container.

The term container as used herein denotes any type of utility item, such as a storage article comprising a storage compartment e.g. a tool box, a tool caddy, sewing box, cooler box, etc.; or utility items and tools such as a power bank, a hand tool, etc.; or a mounting device, such as a mounting platform, mounting rack, a dolly, etc.

According to a first aspect of the present disclosure there is provided a container assembly comprising at least a first container and at least a second container, said first container comprising a mounting surface configured with at least one locking port, and at least one locking latch pivotally articulated to the first container; the second container comprises at least one laterally extending locking tab configured at a bottom surface near a rear portion thereof, and a locking latch engaging lug laterally projecting from a front side of the second container; wherein the least one locking port is configured with a locking tab arresting space extending between a bottom surface of an arresting bridge and a facing surface of the mounting surface, said locking tab arresting space having a tab inlet opening facing a side of the container; and the locking latch is pivotable between a locked position at which it is engageable with a locking latch engaging lug, and an unlocked position at which it is disengaged from a locking latch engaging lug; and wherein the thickness of the locking tab is slightly less than the distance between the bottom surface and the facing surface of the locking port, and wherein the locking tab is spaced from the bottom surface of the container at least the thickness of the arresting bridge.

A designated container can be configured to be a first container and a second container, such that the designated container can be articulated over another first container and respectively another second container can be articulated over the designated container.

According to a second aspect of the disclosure there is container comprising at least a mounting surface configured with at least one locking port, and at least one pivotally articulated locking latch; wherein the least one locking port is configured with a locking tab arresting space extending between a bottom surface of an arresting bridge and a facing surface of the mounting surface, said locking tab arresting space having a tab inlet opening facing the locking latch; said locking latch is pivotable between a locked position at which it is engageable with a locking latch engaging lug of another container, and an unlocked position at which it is disengaged from a locking latch engaging lug.

According to a third aspect of the disclosure there is container comprising at least one laterally extending locking tab configured at a bottom surface near a rear portion thereof, and a locking latch engaging lug laterally projecting from a front side; and wherein the locking tab is engageable with a locking port of another container, and the locking latch engaging lug is configurable for locking arresting a locking latch of the other container.

According to a particular configuration of the disclosure there is a mounting platform comprising a mounting surface configured with at least one locking port, and at least one pivotally articulated locking latch; wherein the least one locking port is configured with a locking tab arresting space extending between a bottom surface of an arresting bridge and a facing surface of the mounting surface, said locking tab arresting space having a tab inlet opening facing the locking latch; said locking latch is pivotable between a locked position at which it is engageable with a locking latch engaging lug of another container, and an unlocked position at which it is disengaged from a locking latch engaging lug.

An imaginary path of insertion of the first container extends between a side of the container and a middle portion thereof, in direction from the locking latch engaging lug towards the locking port; an imaginary path of insertion of the second container extends between a front side of the container and a rear side thereof, in direction from the locking latch towards the locking tab.

Any one or more of the following features, designs and configurations can be applied to any of the aspects of the present disclosure, separately or in various combinations:
The at least one locking latch can be pivotally articulated to the mounting surface or to a side wall of the first container;
The at least one locking latch can be articulated to a side wall portion of the mounting surface, or over the mounting surface;
The at least one locking latch can be pivotally articulated to a side wall portion of a container body;
The at least one locking port can be configured over a top surface of a lid of the container, and the at least one locking latch can be pivotally articulated to a side wall portion of the lid;
Two or more locking ports facing in the same orientation over the mounting surface are disposed in alignment;
A mounting surface of a container can be configured with two sets of at least one locking port, wherein the locking ports of each set are oriented at opposite sides, and wherein each of the two sets extends opposite a respective pivotable locking latch;
The two sets of at least one locking port can be disposed symmetrically over the mounting surface of the container, whereby each set is articulable with a unitary sized second container mounted thereover;
The two sets of at least one locking port can be disposed asymmetrically over the mounting surface of the container, such that one set of at least one locking port extends closer to a respective side end than the other set of at least one locking port, whereby each set is articulable with a different sized second container mounted thereover;
The locking latch can be pivotally articulated to a side wall portion of the first container; wherein at both the locked position and the unlocked position it is disposed substantially parallel to said side wall.
The locking latch can be a handle of the container;
The locking latch can be used for lifting an articulated container assembly;
The locking latch can be gripped from below, by fingers of an individual, at least at the locked position;
The locking latch is spaced from a side wall of the container, at least at the locked position, for gripping the locking latch;
The width of the locking tab is slightly less than the inside minimal width of the arresting bridge;
The bottom surface and the facing surface of the locking port can be substantially parallel to one another;
The locking latch engaging lug can be configured with a locking latch arresting mechanism, for preventing spontaneous displacement of the locking latch from the locked position into the unlocked position;
The locking latch arresting mechanism can be an upward projection at a free end portion of the locking latch engaging lug;
A locking latch catch mechanism can be configured for arresting the locking latch at the unlocked position;
The locking port can extend from a depression configured at the mounting surface;
A top surface of the arresting bridge is substantially coplanar with a top surface of the mounting surface;
The locking port can be configured with side walls, at least partially confining the locking tab arresting space;
The arresting bridge can be a cantilever portion extending from a back wall of the locking port towards a tab inlet opening, facing the locking latch;
The locking port can have a U-like section shape;
The mounting surface of the first container can further be configured with one or more foot rests for receiving respective support feet extending from a bottom face of a second container mountable over the first container;
When the second container is articulated over the first container, a bottom surface of the support feet and the bottom surface of the locking tabs rest over the mounting surface of the first container;
The at least one locking tab is spaced from a base surface of the container and laterally extends and facing outwards towards a nearby side wall of the container;
The second container can be configured with one or more support feet projecting from the bottom surface;
A bottom surface of the locking tab is substantially coplanar with a bottom surface of the support feet, giving rise to an imaginary surface, over which the container is supported;
the facing surface of the locking ports is substantially coplanar with a bottom surface of the foot rests, to ensure parallel articulation of a second container over a first container;
The locking latch engaging lug laterally projects from a front side wall of the second container;
The footprint of the second container can be half the footprint of the first container;
Where two second containers are articulated over a first container at a back-to-back orientation, there resides a small gap between said two second containers;
At an assembled position of the container assembly, the second container is articulated over the first container at an orientation rotated by 90°;
At its locked position the one or more locking latch extends above the locking latch engaging lug;
The locking latch engaging lug can extend above a base surface of the container;
The at least two locking latch engaging lugs can be spaced apart, giving rise to a gripping space, facilitating a user to obtain good grip of the handle/locking latch;
The number, size and shape of locking tabs as well as of support feet extending from a bottom face of a container, and likewise the number of locking ports, locking latch engaging lugs and locking latches, can vary.
The one or more locking tab are in register with respective one or more locking port;
The locking latch engaging lugs are in register with the locking latch;
The locking latch can be pivotally articulated to the mounting surface; wherein at the locked position it is disposed upright over the mounting surface, and at the unlocked position it is disposed over the mounting surface;
The distance between the tab inlet opening of the locking tab arresting space and the pivoting axis of the locking latch, is substantially similar to the distance between a free end of the locking tab and an arresting portion of the locking latch engaging lug.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a perspective view of a modular container assembly according to an example of the disclosure;

FIG. 1B is perspective view of a second sub-assembly of the assembly of FIG. 1A;

FIG. 2A is perspective view of a first sub-assembly of the assembly of FIG. 1A;

FIG. 2B is an exploded front view of the containers of FIG. 2A;

FIG. 2C is an exploded rear view of the containers of FIG. 2A;

FIG. 2D is a section along line 2D-2D in FIG. 2A;

FIG. 2E is an enlargement of the portion marked 2E in FIG. 2D;

FIG. 2F is an enlargement of the portion marked 2F in FIG. 2E;

FIG. 3 is an enlargement of the portion marked 3, sectioned along line 3-3 in FIG. 2A;

FIG. 4 is an enlargement of the portion marked 4 in FIG. 2A;

FIG. 5A is a section along line 5A-5A in FIG. 2A;

FIG. 5B is an enlargement of the portion marked 5B in FIG. 5A;

FIG. 6A is a section along line 6A-6A in FIG. 5A;

FIG. 6B is an enlargement of the portion marked 6B in FIG. 6A;

FIG. 7A is a section along line 7A-7A in FIG. 1B;

FIG. 7B is an enlargement of the portion marked 7B in FIG. 7A;

FIG. 7C is a section along line 7C-7C in FIG. 1B;

FIG. 7D is an enlargement of the portion marked 7D in FIG. 7C;

FIG. 7E is an enlargement of the portion marked 7E in FIG. 7C;

FIG. 8A is perspective view of a second sub-assembly of the assembly of FIG. 1A;

FIG. 8B is a section along line 8B-8B in FIG. 8A;

FIG. 8C is a section along line 8C-8C in FIG. 8A;

FIG. 8D is a section along line 8D-8D in FIG. 8A;

FIG. 8E is a section along line 8E-8E in FIG. 8A;

FIG. 9A is a perspective view of a wheeled container according to another example of the present disclosure;

FIG. 9B illustrates the container of FIG. 9A with a second container articulated thereover, according to an example of the disclosure;

FIG. 9C is an enlargement of the portion marked 9C in FIG. 9B;

FIG. 10 is a perspective view of a dolly, according to an example of the disclosure;

FIG. 11A is a top perspective view of a modular container assembly according to another example of the disclosure;

FIG. 11B is a first level exploded view of FIG. 11A, however with a second container illustrated at a bottom perspective view;

FIG. 12A is an enlargement of the portion marked 12A in FIG. 11B;

FIG. 12B is an enlargement of the portion marked 12A in FIG. 12A;

FIG. 13A is a portion of a section taken along line 13A-13A in FIG. 11A; and

FIG. 13B is a portion of a section taken along line 13B-13B in FIG. 11A.

### DETAILED DESCRIPTION OF EMBODIMENTS

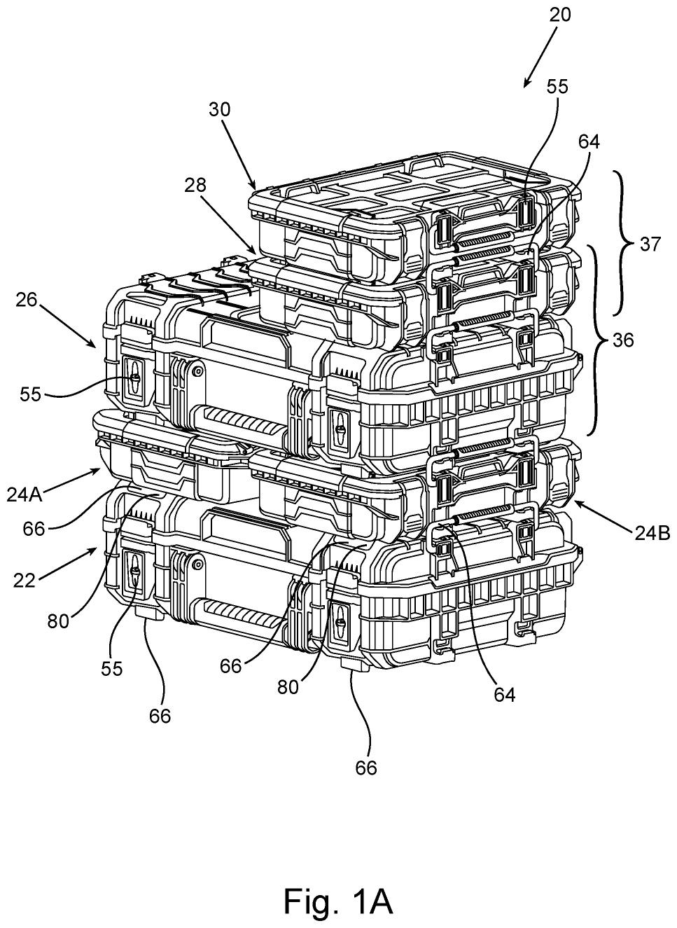

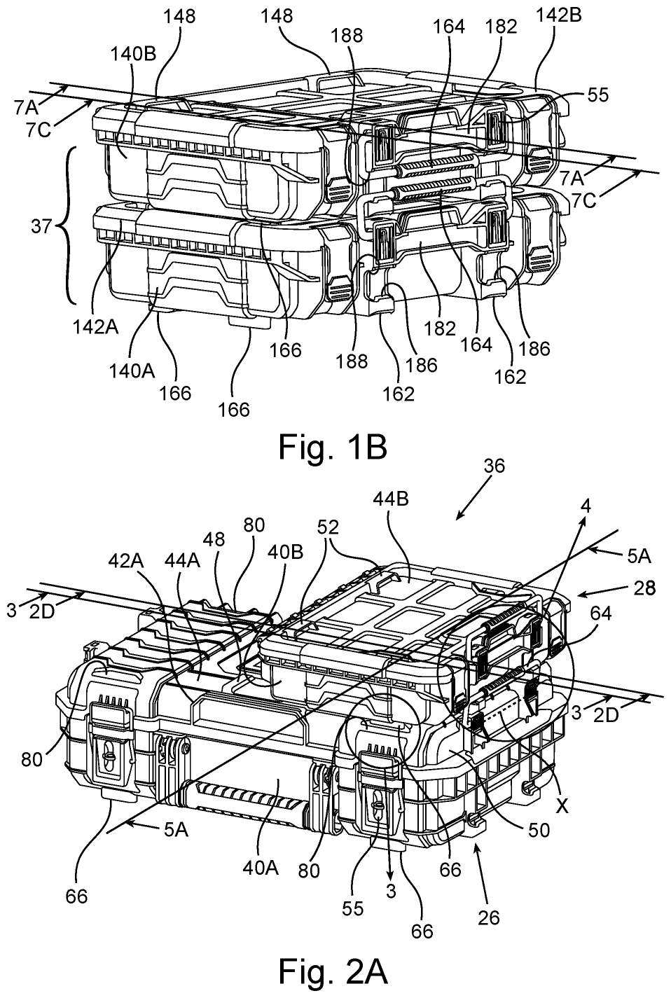

Attention is first directed to FIG. 1A, illustrating a modular container assembly according to an example of the present disclosure, generally designated 20. In this example the assembly comprises a first, base container 22, a pair of half foot-print, second containers 24A and 24B articulated over the first container at a back-to-back orientation, a second large container 26 mounted over the half foot-print containers 24A and 24B, yet a half foot-print container 28 articulated over the second large container 26, and a still another half foot-print container 30 articulated over the half foot-print container 28.

In the example of FIG. 1A each of the containers is a utility container for storage and handling of articles, each comprising a body with a lid articulated thereto. However, it is appreciated, and as will be exemplified below, that the term container as includes other configurations as well, and can be any type of utility item such as a storage article comprising a storage compartment, e.g. a tool box, a tool caddy, sewing box, cooler box, etc.; or utility items and tools such as a power bank, a hand tool, etc.; or a mounting device, such as a mounting platform, mounting rack, a dolly, etc.

Further, it is appreciated that the term first container and second container are respective definitions, used to distinguish any container (‘first container’) having articulated thereover another container (‘second container’). Accordingly, in a tower assembly of the type illustrated in FIG. 1A, base container 22 is a first container with respect to second half foot-print 24A and 24B. Likewise, second large container 26 constitutes a first container with respect to half foot-print container 28, being a second container, whilst half foot-print container 28 constitutes a first containers with respect to half foot-print container 30, being a second container.

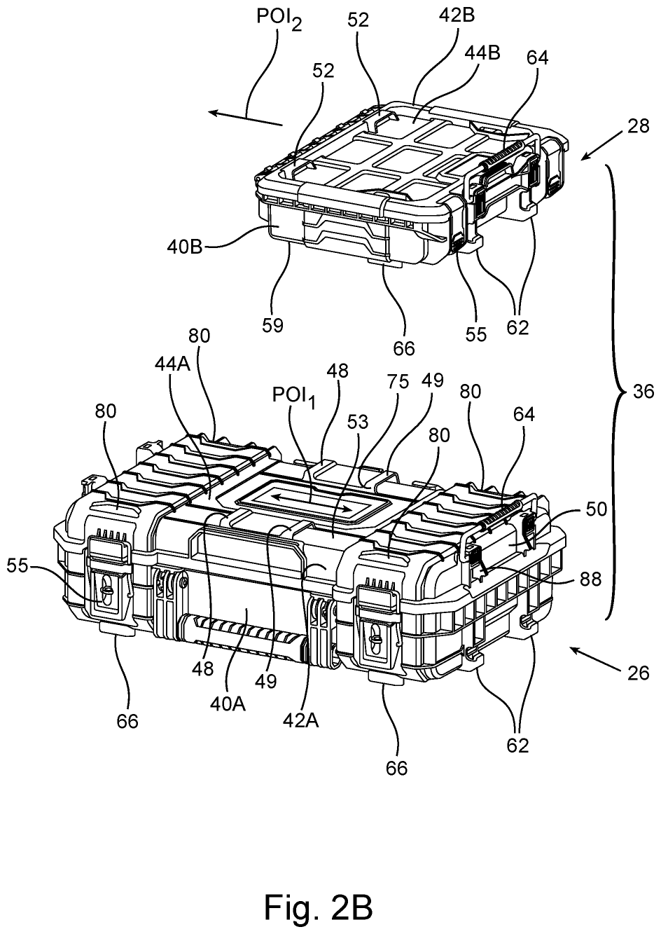

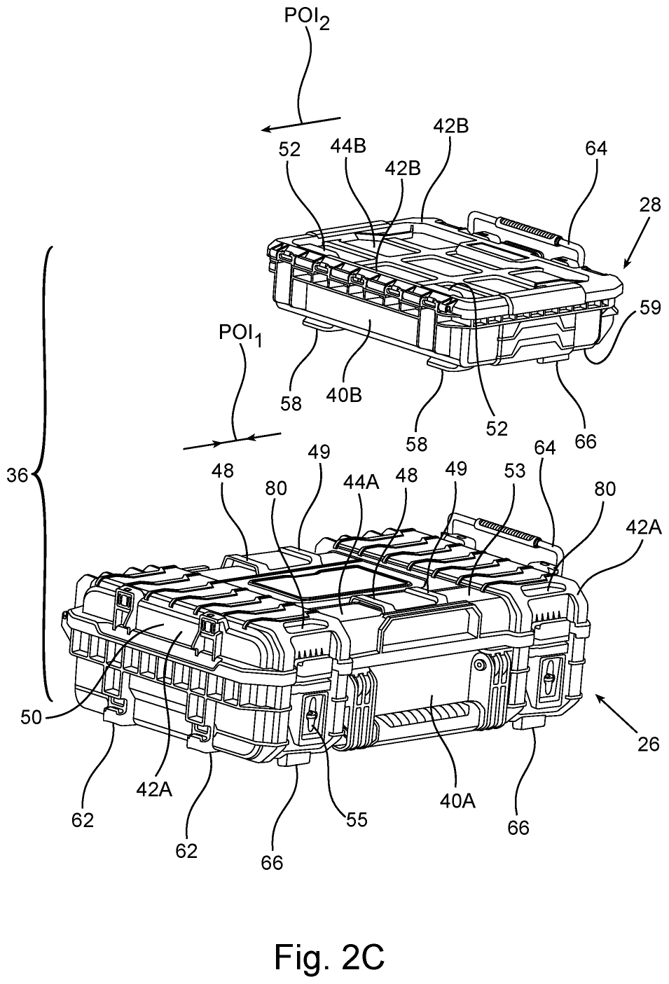

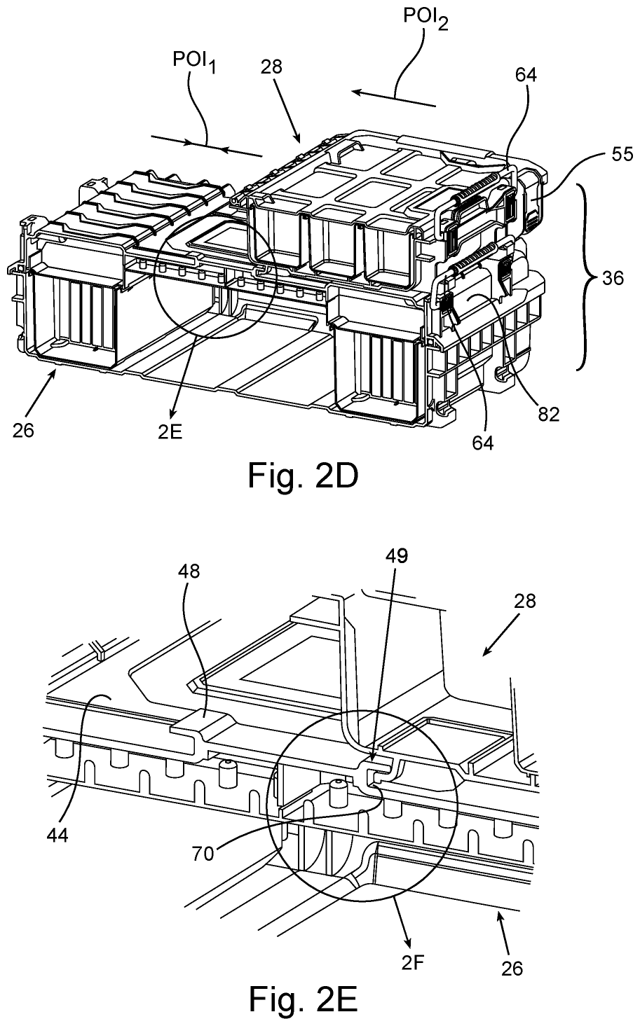

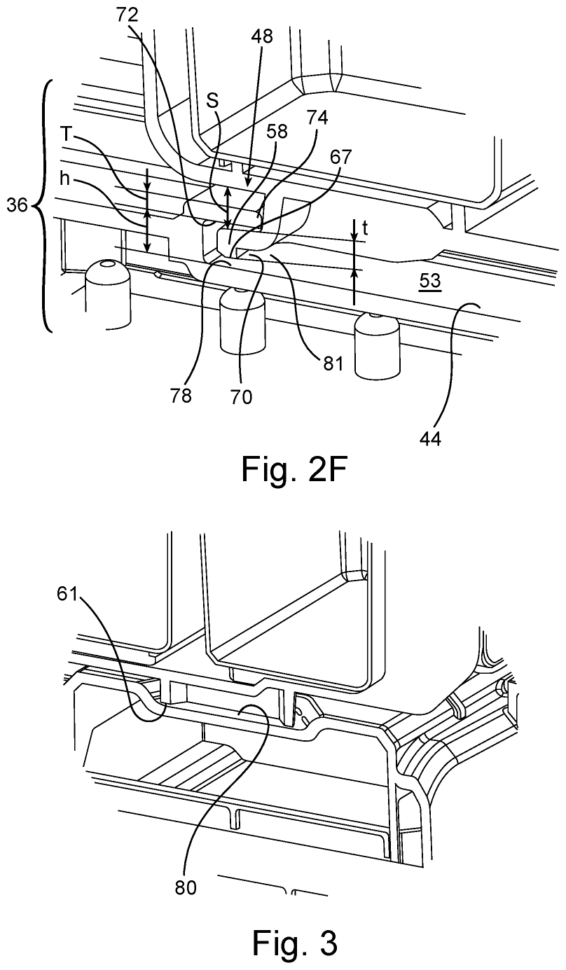

FIG. 2A is a sub-assembly illustrating the assembly 36 comprising the large container 26 and the half foot-print container 28. As can be seen, with further reference to FIGS. 2B and 2C, each of the containers 26 and 28 comprises a base portion, namely a compartment portion 40A and 40B, respectively, and a lid 42A and 42B, pivotally articulated to the respective compartment portion 40A and 40B.

The lids 42A and 42B of the containers 26 and 28 are each configured with a mounting surface 44A and 44B respectively. Mounting surface 44A is configured with two locking ports 48 facing in one direction and two locking ports 49 facing in an opposite direction, however symmetrically positioned at a central portion of the lid 42A. Mounting surface 44B is configured with a pair of locking ports 52, disposed at a rear portion of the container 28 (namely, on the lid 42B). It is noted that the locking ports 48 each extend from a depression 53 configured at the mounting surface 44.

Lid 42A of container 26 is configured at each of its respective walls 50 with a pivotally articulated locking latch 64 displaceable between an upright, locked position (as in FIGS. 2A-2C), and an unlocked position (left side in FIG. 2C), where the locking latch 64 is disposed against the side wall of the lid 42A. Locking latch 64 facilitates also as a carrying handle, as will be discussed hereinafter.

A bottom base of the compartment portion 40B of the second container 28 is configured, near a rear portion thereof, with two locking tabs 58 (FIG. 2C), spaced from the base surface 59 and laterally extending, facing outwardly towards a near side wall.

Extending from the compartment portion 40B, of the second container 28, there are a pair of locking latch engaging lugs 62, laterally projecting from a side of the second container and above the base surface 59. It is noted that container 26 is also configured with locking latch engaging lugs 62, for articulation over another container by a pivotal locking latch 64, however not using a locking port 52 and locking tab 58 mechanism, as per the present disclosure. Such a configuration is useful, in the example of FIG. 1A, for articulating the large container 26 over the half foot-print containers 24A and 24B by the locking latch 64, or otherwise for articulating two such containers 26 and 22 over one another (not shown). It is appreciated that the space between the two locking latch engaging lugs 62 gives rise to a gripping space, facilitating a user to obtain good grip of the handle/locking latch.

Also extending from base surface 59 of the second container 28, there is a pair of support feet 66, having a bottom surface 61 which together with a bottom surface 67 of the locking tabs 58 give rise to an imaginary planar surface over which the container 28 can be levelled supported over a surface.

It is further appreciated that the number, size and shape of locking tabs as well as of support feet extending from a bottom face of a container, and likewise the number of locking ports, locking latch engaging lugs and locking latches, can vary. However, it is of importance that one or more locking tab be in register with respective one or more locking port, and also that the locking latch engaging lugs be in register with the locking latch.

Further attention is now made to the above disclosed elements, in greater detail. Referring first to the locking ports 48 of the first container (best seen in FIG. 2F), these are configured with a locking tab arresting space 70 extending between a bottom surface 72 of an arresting bridge 74 and a facing surface 78 of the mounting surface 44. The locking tab arresting space 70 extends between side walls 75 and has a tab inlet opening 81 facing a side 82 of the container. The above description applies also to locking ports of the second container.

An imaginary path of insertion POI₁, of the first container, extends between a side 82 and a middle portion thereof (namely towards the locking ports 48), in direction from the locking latch engaging lug towards the locking port.

The thickness t of the locking tab, measured from a bottom most surface to a top surface is slightly less than the distance d between the bottom surface 72 and the facing surface 78 of the locking port, and the distance S of the locking tab from the bottom surface of the container is at least the thickness T of the arresting bridge 74. Also, as best seen in FIG. 6B, the width W of a locking tab is slightly less than the inside minimal width w of the arresting bridge 74.

An imaginary path of insertion POI₂, of the second container, extends between a front side of the container and a rear side thereof, in direction from the locking latch 64 towards the locking tab 58, wherein at articulation of a second container over a first container, the POI₁ and POI₂ are parallel.

A mounting surface 44A of the first container 26 is configured with foot rests 80 disposed in register with support feet 66 extending from base surface 59 of the second container 28, wherein when the second container is articulated over the first container said support feet are received in and supported by the foot rests 80.

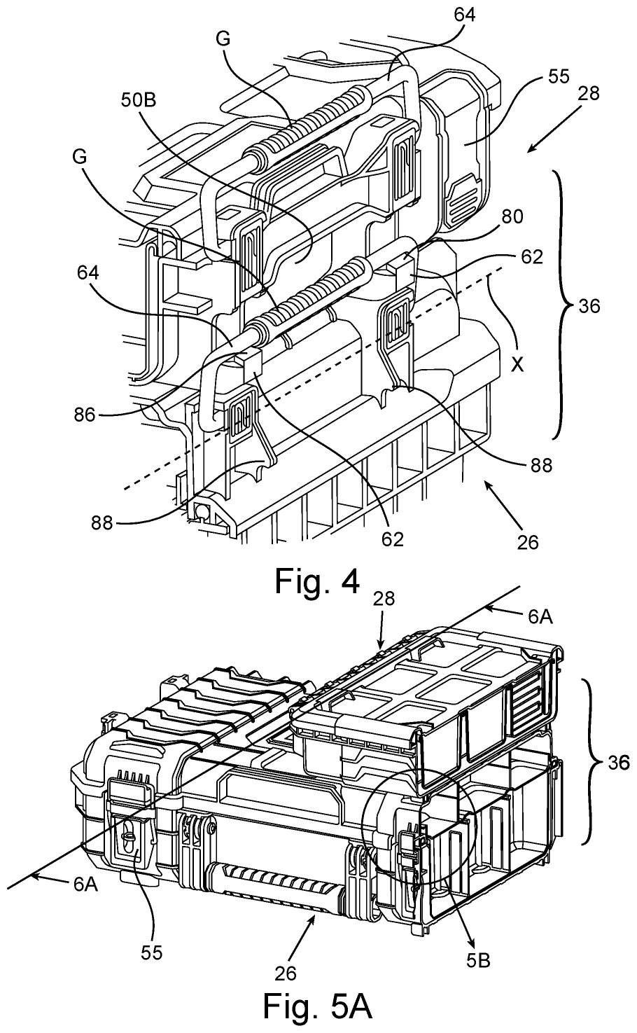

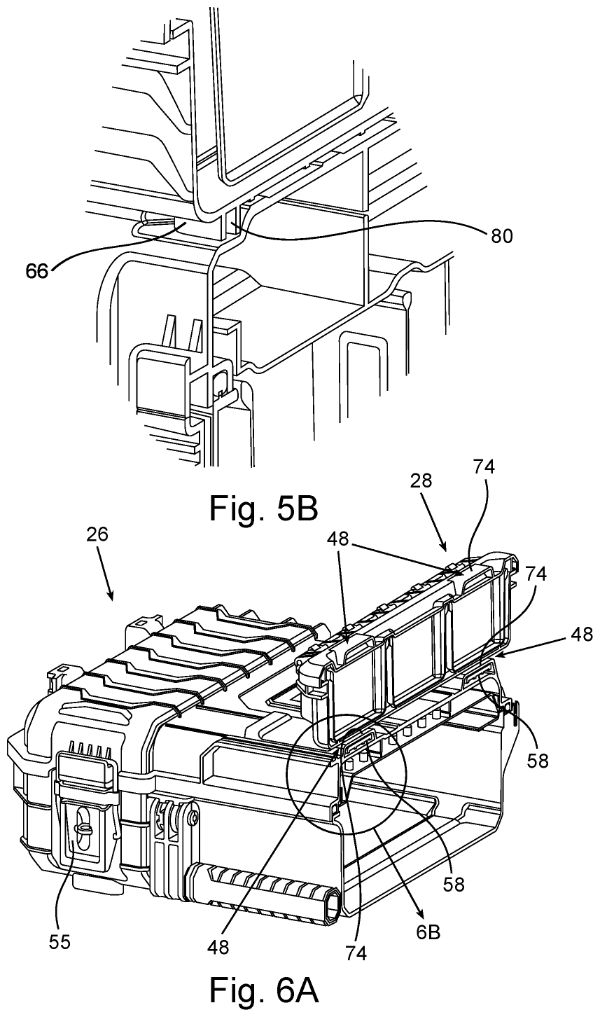

Best seen in FIG. 4, the at least one locking latch 64 is pivotally articulated about axis X to the side wall 50 of the first container, and comprises a central thickened grip portion G, with bare side portions arrestable by locking latch engaging lugs 62 of the second container. A locking latch arresting mechanism, in the form of an upward projection 86 near a free end of the locking latch engaging lugs 62, is provided for retaining the locking latch 64 engaged over the latch engaging lugs 62 and preventing spontaneous displacement of the locking latch 64 from the locked position into the unlocked position. Also at its unlocked position the locking latch 64 is arrested by downwards facing hooked portions 88, configured for retaining the locking latch 64 at its unlocked position.

It is seen that the locking latch 64 is spaced from the side wall 50B of the second container 28, and further, the two locking latch engaging lugs 62 are spaced apart, thus facilitating gripping of the locking latch buy users fingers (not shown), as said locking latches 64 facilitate both as a locking latch for articulating and locking the two containers over one another, and as a handle used for lifting an articulated container assembly. Also, the locking latch 64 is substantially parallel to the side wall of the container at both the locked position and the unlocked position.

Articulating any second container over any first container takes place in three easy steps:
a. Introducing the locking tabs 58 of the second (top) container into the respective locking tab arresting space 70 of the locking ports 48 of the first (bottom) container;
b. positioning the support feet 66 of the second container into rest within the foot rests 80 of the first container; and
c. pivoting the locking latch 64 of the first container from its unlocked position into its locked position and arresting it at the locked position over the locking latch engaging lugs 62 of the second container.

Disengaging the articulated containers takes place in a reverse sequence of operations.

If yet a container (a ‘next container’) is now to be articulated over the top (second) container, then the same sequence of operations takes place, wherein the next container is now the so-called second container and the second container serve as a first container.

Noting the tolerance between the locking tabs 58 and the respective locking tab arresting space 70 of the locking ports 48, and that between the support feet 66 and the foot rests 80, the second container is placed almost planar over the second container, with only little tilt required, if any.

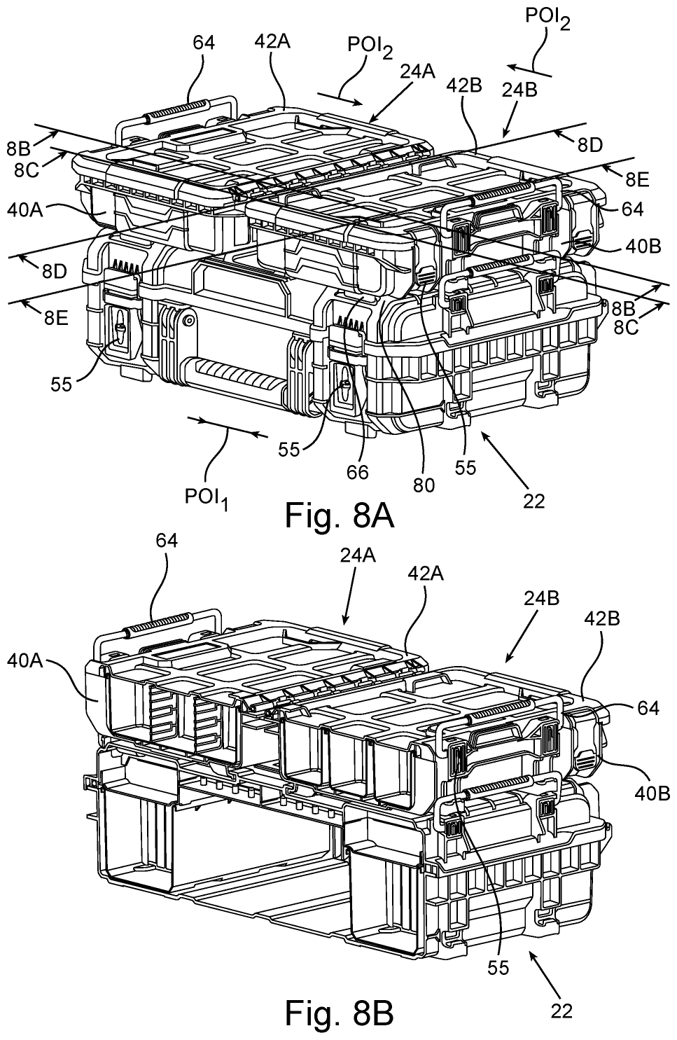

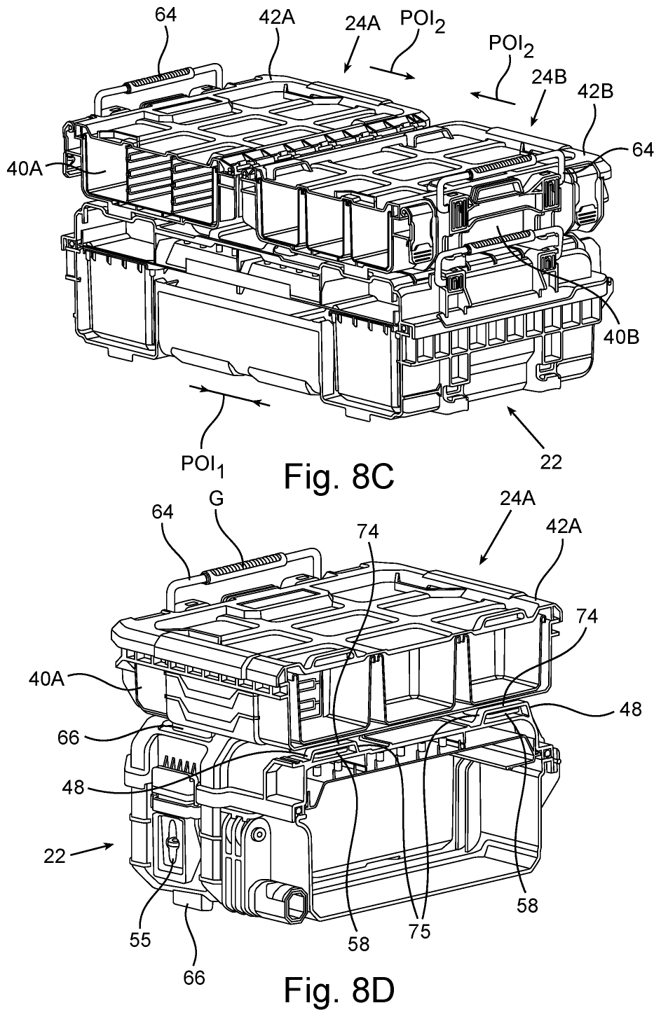

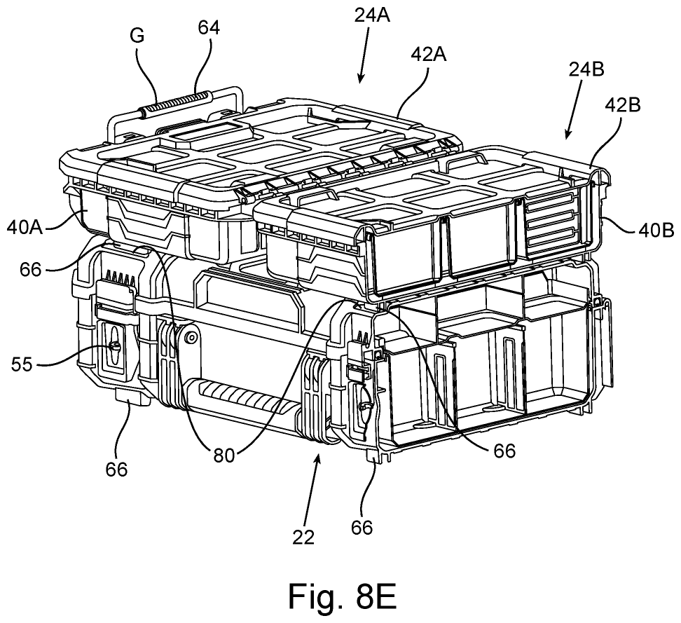

Taking a look at the assembly 20 of FIG. 1A, it is apparent that the two half foot-print containers 24A and 24B (disposed in a back-to-back orientation as in FIGS. 8A to 8E) are individually and independently articulated over the base container 22 in the manner described herein above and wherein like reference numbers have been designated, for sake of clarity.

The arrangement is such that the lid 42A and 42B of each container 24A and 24B respectively, can be independently opened (if they are top level containers). For that purpose, the mounting surface 44A of container 22 is configured with two locking ports 48 facing in one direction and two locking ports 49 facing in an opposite direction.

The two containers 24A and 24B are equally leveled and are each configured with a locking latch 64 (disposed at their respective front side wall) thus facilitating articulating there above a large container 26 (full foot-print, similar to that of container 22), however wherein articulating thereof takes place only with the two locking latches 64, one of each of containers 24A and 24B (i.e. without participation of locking ports 48 and locking tabs 58 in the articulation process).

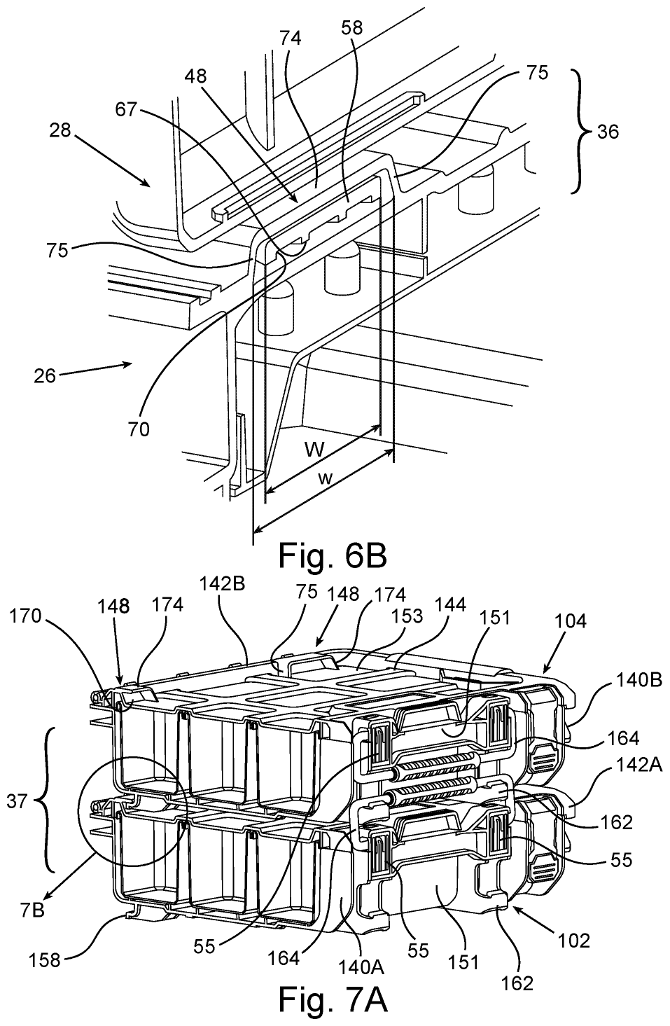

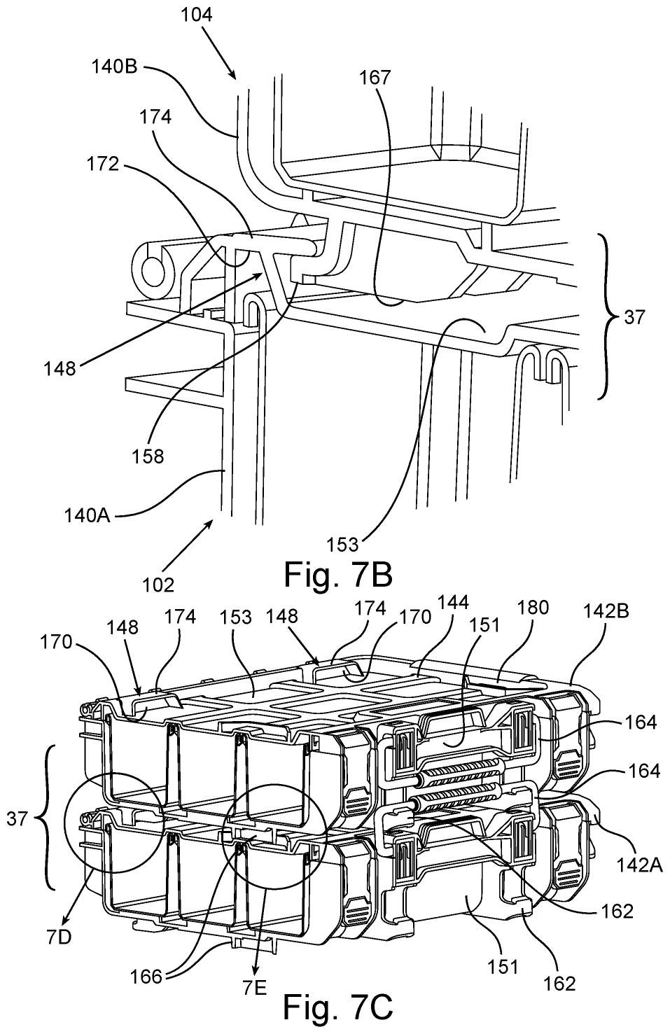

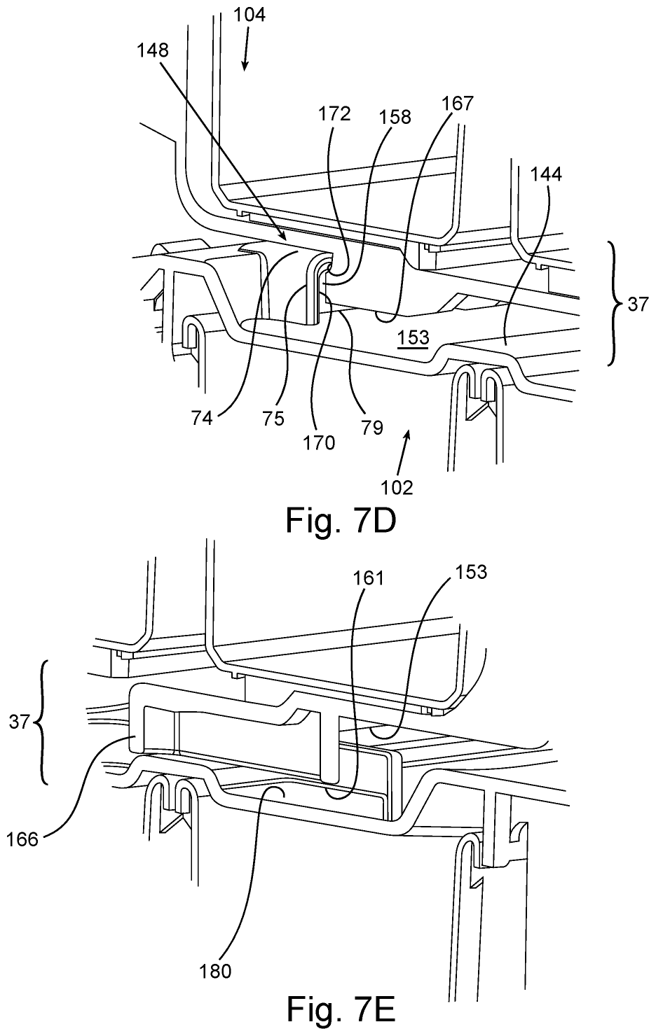

However, if required, a next half foot-print container can be mounted over one or each of the two containers 24A and 24B. Such articulation (half foot-print container over half foot-print container) is exemplified by sub-assembly 37 illustrated in FIGS. 1A, 1B and 7A to 7E, wherein like elements are given like reference numbers, though shifted by 100. In this example the first (bottom) container is designated 102 and the second (top) container is designated 104.

The second (top) container 104 is identical to container 28 disclosed herein before. In fact, the first (bottom) container 102 is identical to second container 104. However, theses containers 102 and 104 differ from the first container 26 discussed above, in that the locking latches 164 are pivotally articulated a side wall portion 151 of the compartment portion 140A and 140B of each container 102 and 104, respectively (rather than to the lid portion).

Articulating and locking second container 104 over first container 102 takes place similar to the disclosure above, namely following the following steps:
a. Introducing the locking tabs 158 of the second (top) container into the respective locking tab arresting space 170 of the locking ports 148 of the first (bottom) container;
b. positioning the support feet 166 of the second container into rest within the foot rests 180 of the first container; and
c. pivoting the locking latch 164 of the first container from its unlocked position into its locked position and arresting it at the locked position over the locking latch engaging lugs 162 of the second container.

Disengaging the articulated containers takes place in a reverse sequence of operations.

Each container, whether a first container or a second container, whether a large container or a half foot-print container, is configured with at least one, typically two, closing latches 55.

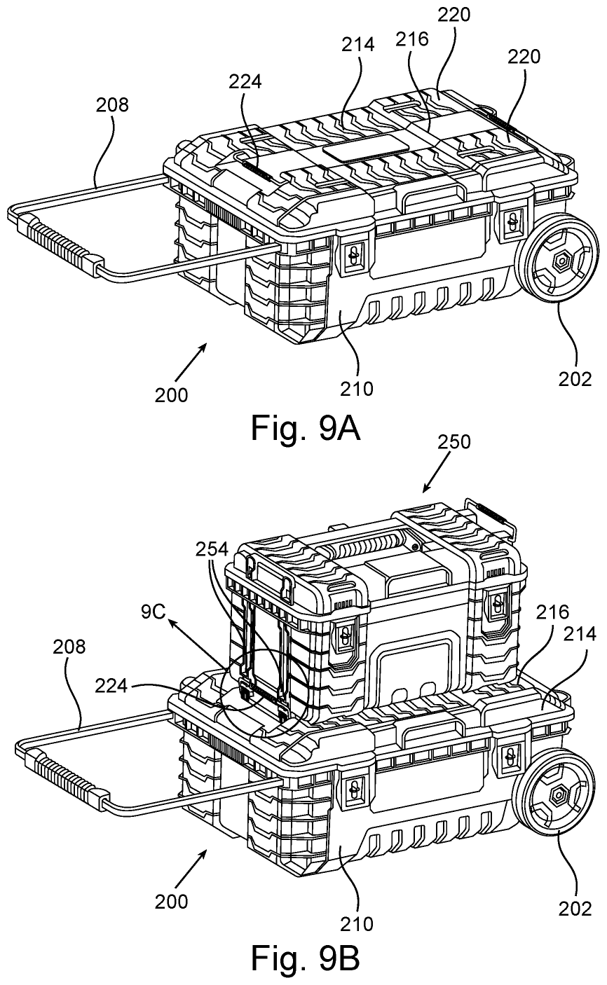

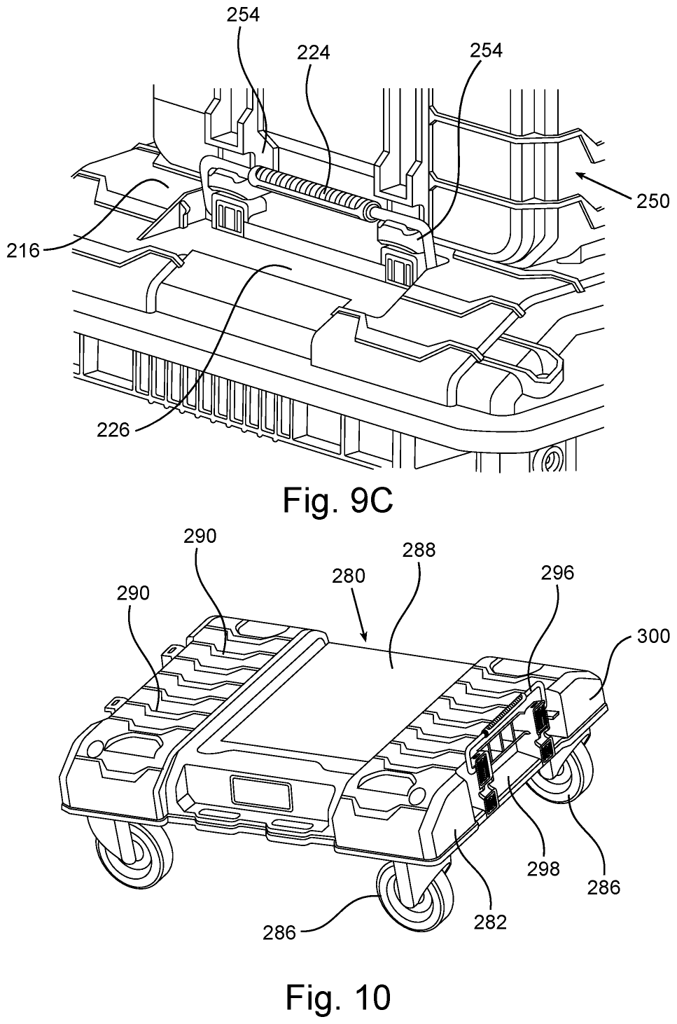

FIGS. 9A to 9C are directed to a modification of the disclosure, however following the essential features thereof. In the example of FIGS. 9A to-9C there is illustrated a first (base) container generally designated 200, configured with a pair of rear wheels 202 and a telescopic manipulating handle 208 (displaceable between a retracted position and an extended position, as in the drawings). The container 200 has a compartment portion 210 and a lid 214 pivotally articulated thereto.

The lid 214 is has a top mounting surface 216, configured with a pair of locking ports 220 at a rear portion of the lid 214, and a locking latch 224 over a top, front portion of the lid 214. Each of the locking ports 220 is similar to locking ports disclosed hereinbefore (i.e. locking ports 48, 52 and 148), and the locking latch 224 is similar to the locking latch disclosed hereinbefore (i.e. locking latch 64 and 164), however with a difference residing in that the locking latch 224 is pivotally secured at the top surface of the lid 214, wherein at the unlocked position it is flush within a depression 226 over the lid (in a direction facing the handle 208), and at the locked position it is pivoted by 90° into articulating with locking latch engaging lugs of a second container 250 articulated over the container 200.

The second container 250 is configured at a rear bottom face thereof with a pair of locking tabs (not seen) of identical structure as locking tabs (58; 158) in the previous examples. A front, bottom portion of the second container 250 is configured with a pair of locking lugs 254 laterally extending and facing outwardly.

Articulating the second container 250 over the first container 210 takes place similar to the previous examples, namely:
a. Introducing the locking tabs of the second (top) container 250 into the respective locking tab arresting space of the locking ports 220 of the first (bottom) container;
b. positioning the bottom face of the second container 250 over the top face 216 of the first container 210; and
c. pivoting the locking latch 224 of the first container 210 from its unlocked position into its locked position and arresting it at the locked position over the locking latch engaging lugs 254 of the second container 250.

Disengaging the articulated containers takes place in a reverse sequence of operations.

It is appreciated that the bottom face of the second container can be configured with support feet similar to the disclosure of the previous examples, and likewise the first container would be configured with respective foot rests disposed in register over its top surface.

FIG. 10 illustrates a dolly 280 configured as a first container according to the present disclosure, whereby a second container (not shown) according to the present disclosure is articulable thereover. The dolly 280 comprises a rigid cargo bed 282 fitted at a bottom thereof with four swivel wheels 286. A top, mounting surface 288 of the cargo bed 282 is configured at one side thereof with a pair of locking ports 290, of same configuration as discussed hereinabove with respect to previous examples. A pivotally articulated locking latch 296 is pivotally secured within a niche 298 at a side wall 300, and is displaceable between an upright, locked position (as in FIG. 10) and an unlocked position (not shown) rotated by 180°, facing down.

The arrangement is such a container (not shown) comprising a pair of locking tabs and locking latch engaging lugs can be articulated over the dolly 280, as discussed herein before.

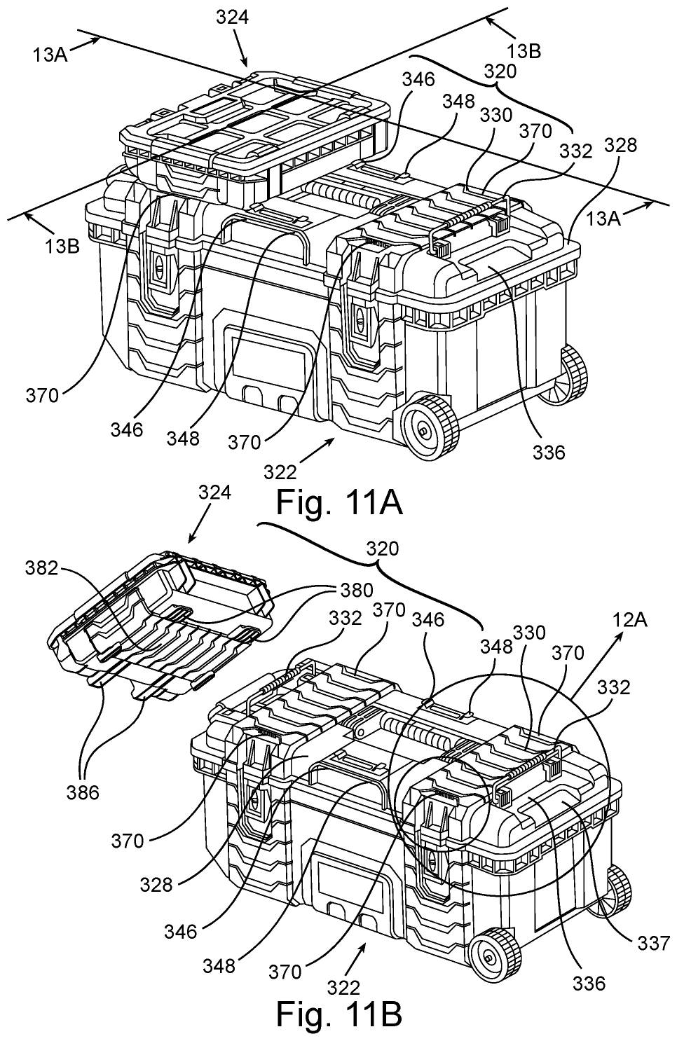

An additional example is illustrated in FIGS. 11A to 13B, showing a sub-assembly modular container assembly generally designated 320, comprising a wheeled base (first) container 322, and a top (second) container 324.

The second container 324 is identical, for example to the half foot-print container 28 exemplified above, and reference is made thereto. The first container 322 is similar to container 200 of FIGS. 9A-9C as far as the locking latch disposed over the top mounting surface of the lid, however, is configured with a different locking port.

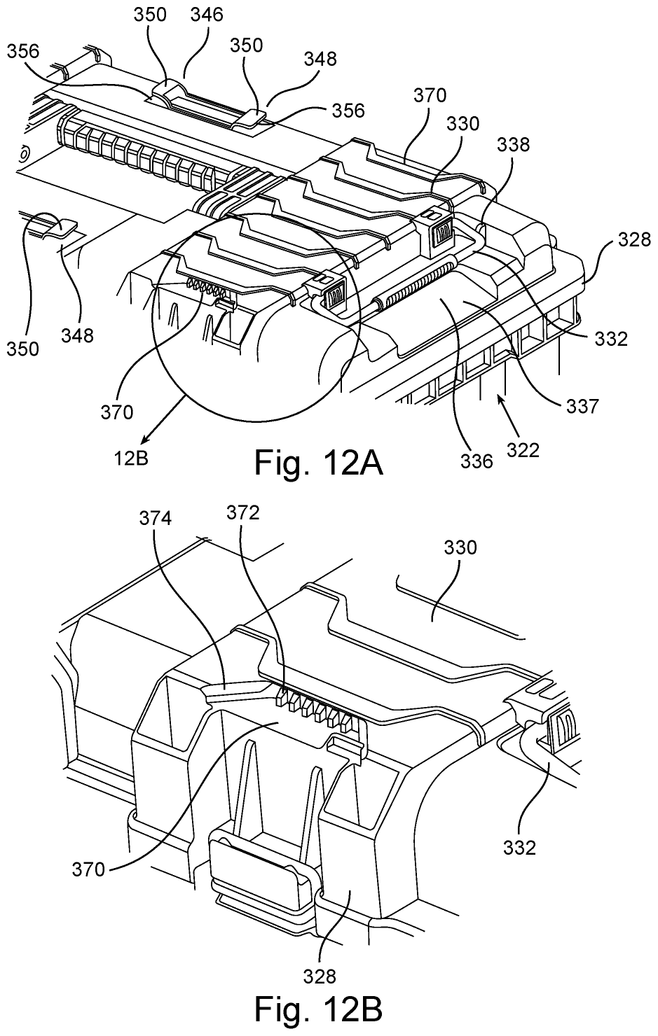

Container 322 is a wheeled, base container, configured with a lid 328 pivotally articulated thereto. A top mounting face 330 of the lid 328 is configured with a locking latch 332 near its respective ends, each said locking latch 332 disposed within a depressed portion 336 (the latch being accessible from below at a depression 337) and being pivotable between an unlocked position (FIG. 12A) and a locked position (FIGS. 11A and 11B), at the unlocked position the locking latch 332 is retained by a latch arresting member 338.

Particular attention is directed to the locking ports disposed at a mid-portion of the mounting face 330. Two locking ports 346 are disposed facing in one direction and two locking ports 348 are disposed facing in an opposite direction, at a back-to-back orientation. Each of the locking ports 346 and 348 has a U-like cross section, without side walls, and wherein the arresting bridge 350 is a cantilever like portion, extending from a back wall 352 of the locking port towards a tab inlet opening 354, facing the locking latch 332 and defining therein a locking tab arresting space 356. Apart for that, the locking ports 346 and 348 are functionally similar to the locking ports of the previous examples, as far as size ratio.

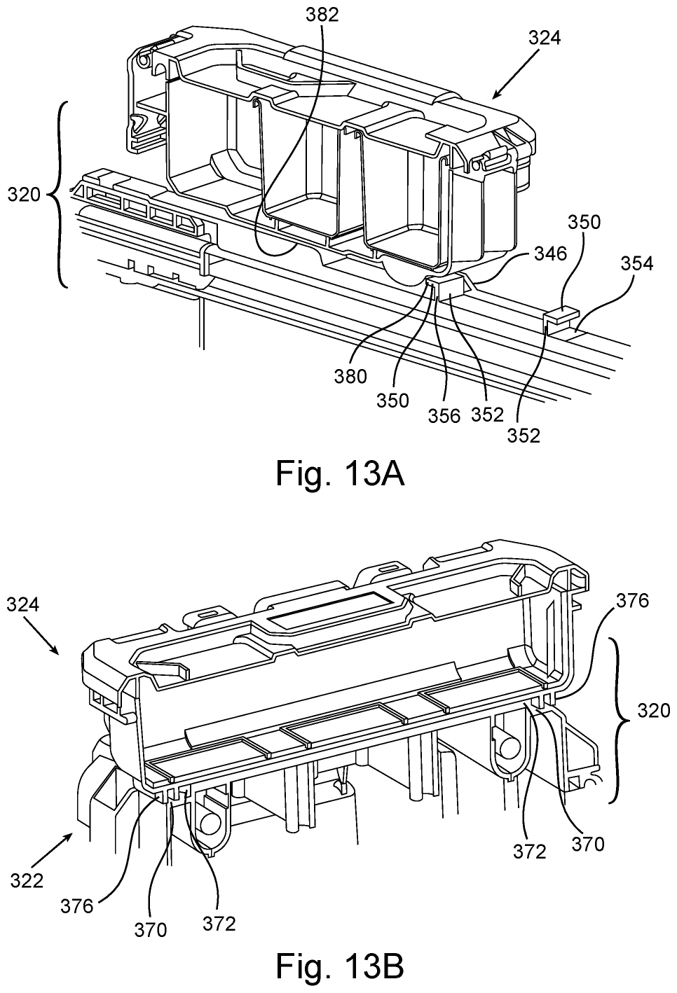

The lid 328 is configured with several foot rests 370 having sliding surface 372 and 374 for directing support feet 376 of the second container (FIG. 13B) into position within the foot rests 370.

The articulation arrangement of the second container 324 over the first container 322 is facilitated exactly as disclosed hereinabove with reference to the previous examples, wherein a locking tab 380 (same as disclosed above; at a bottom face 382 of the second container 324) is engageable within the locking tab arresting space 356 (FIG. 13A), with support feet 376 received over and within the foot rests 370 (FIG. 13B), upon which the locking latch 332 of the first container is pivoted into its locked position, to thereby engage locking latch engaging lugs 386 of the second container 324 (locking latch engaging lugs 386 are similar to locking latch engaging lugs 62 of the previous examples, and reference is made thereto).

1. A container assembly comprising at least a first container and at least a second container, said first container comprising a mounting surface configured with at least one locking port, and at least one locking latch pivotally articulated to the first container; the second container comprises at least one laterally extending locking tab configured at a bottom surface near a rear portion thereof, and a locking latch engaging lug laterally projecting from a front side of the second container;
wherein the least one locking port is configured with a locking tab arresting space extending between a bottom surface of an arresting bridge and a facing surface of the mounting surface, said locking tab arresting space having a tab inlet opening facing a side of the container; and the locking latch is pivotable between a locked position at which it is engageable with a locking latch engaging lug, and an unlocked position at which it is disengaged from a locking latch engaging lug;
and wherein the thickness of the locking tab is slightly less than the distance between the bottom surface and the facing surface of the locking port, and wherein the locking tab is spaced from the bottom surface of the container at least the thickness of the arresting bridge.

2. The container assembly of claim 1, wherein the at least one locking latch is pivotally articulated to the mounting surface or to a side wall of the first container.

3. The container assembly of claim 1, wherein the at least one locking latch is articulated to a side wall portion of the mounting surface, or over the mounting surface.

4. (canceled)

5. (canceled)

6. The container assembly of claim 1, wherein the at least one locking port is configured over a top surface of a lid of the container, and the at least one locking latch can be pivotally articulated to a side wall portion of the lid.

7. The container assembly of claim 1, comprising two or more locking ports facing in the same orientation over the mounting surface are disposed in alignment.

8. The container assembly of claim 1, wherein a mounting surface of a container is configured with two sets of at least one locking port, wherein the locking ports of each set are oriented at opposite sides, and wherein each of the two sets extends opposite a respective pivotable locking latch.

9. The container assembly of claim 8, wherein the two sets of at least one locking port are disposed symmetrically over the mounting surface of the container, whereby each set is articulable with a unitary sized second container mounted thereover.

10. The container assembly of claim 8, wherein the two sets of at least one locking port are disposed asymmetrically over the mounting surface of the container, such that one set of at least one locking port extends closer to a respective side end than the other set of at least one locking port, whereby each set is articulable with a different sized second container mounted thereover.

11. (canceled)

12. (canceled)

13. (canceled)

14. The container assembly of claim 1, wherein the width of the locking tab is slightly less than the inside minimal width of the arresting bridge.

15. The container assembly of claim 1, wherein the bottom surface and the facing surface of the locking port are substantially parallel to one another.

16. The container assembly of claim 1, wherein the locking latch engaging lug is configured with a locking latch arresting mechanism, configured for preventing spontaneous displacement of the locking latch from the locked position into the unlocked position.

17. (canceled)

18. The container assembly of claim 1, wherein a locking latch catch mechanism is configured for arresting the locking latch at the unlocked position.

19. The container assembly of claim 1, wherein the locking port extends from a depression configured at the mounting surface.

20. The container assembly of claim 1, wherein a top surface of the arresting bridge is substantially coplanar with a top surface of the mounting surface.

21. (canceled)

22. (canceled)

23. (canceled)

24. The container assembly of claim 1, wherein the at least one locking tab is spaced from a base surface of the container and laterally extends and facing outwards towards a nearby side wall of the container.

25. (canceled)

26. (canceled)

27. The container assembly of claim 1, wherein the locking latch engaging lug laterally projects from a front side wall of the second container.

28. The container assembly of claim 1, wherein the footprint of the second container is half the footprint of the first container.

29. (canceled)

30. The container assembly of claim 1, wherein at its locked position the one or more locking latch extends above the locking latch engaging lug.

31. The container assembly of claim 1, wherein the locking latch engaging lug extends above a base surface of the container.

32. The container assembly of claim 1, wherein at least two locking latch engaging lugs are spaced apart, giving rise to a gripping space, facilitating a user to obtain good grip of the locking latch.

33. The container assembly of claim 1, wherein the one or more locking tabs are in register with respective one or more locking port.

34. The container assembly of claim 1, wherein the locking latch engaging lugs are in register with the locking latch.

35. (canceled)

36. The container assembly of claim 1, wherein the arresting bridge has a cantilever portion extending from a back wall of the locking port towards a tab inlet opening, facing the locking latch.

37. A container comprising at least a mounting surface configured with at least one locking port, and at least one pivotally articulated locking latch; wherein the least one locking port is configured with a locking tab arresting space extending between a bottom surface of an arresting bridge and a facing surface of the mounting surface, said locking tab arresting space having a tab inlet opening facing the locking latch; said locking latch is pivotable between a locked position at which it is engageable with a locking latch engaging lug of another container, and an unlocked position at which it is disengaged from a locking latch engaging lug.

38. (canceled)

39. A mounting platform comprising a mounting surface configured with at least one locking port, and at least one pivotally articulated locking latch; wherein the least one locking port is configured with a locking tab arresting space extending between a bottom surface of an arresting bridge and a facing surface of the mounting surface, said locking tab arresting space having a tab inlet opening facing the locking latch; said locking latch is pivotable between a locked position at which it is engageable with a locking latch engaging lug of another container, and an unlocked position at which it is disengaged from a locking latch engaging lug.
